(19) United States
(12) Patent Application Publication
(10) Pub. No.: US 2012/0185281 A1
(43) Pub. Date: Jul. 19, 2012

(54) PEER RECOMMENDER- USE OF INTELLIGENTS TO STREAMLINE SEARCH OF PEERS FOR COLLABORATION PURPOSES AND ITS DISPLAY

(75) Inventor: Eric Cohen-Solal, Ossining, NY (US)

(73) Assignee: KONINKLIJKE PHILIPS ELECTRONICS N.V., EINDHOVEN (NL)

(21) Appl. No.: 13/498,518

(22) PCT Filed: Aug. 19, 2010
(86) PCT No.: PCT/IB2010/053756

§ 371 Date: Mar. 27, 2012

Related U.S. Application Data
(60) Provisional application No. 61/246,269, filed on Sep. 28, 2009.

(51) Int. Cl. G06Q 50/22; G06Q 50/24

(52) U.S. Cl. 705/3; 705/2

(57) ABSTRACT

A method for scheduling a medical consultation includes a generating a list of consultation criteria. A plurality of clinician profiles stored in a server are searched in accordance with the consultation criteria. A list of consulting clinicians is generated from clinician profiles that correlate to the consultation criteria and displaying or storing in memory the list of the consulting clinicians.

The present application relates to health care communication systems. It finds particular application in managing and facilitating medical consultations between colleagues through a real time search of colleagues resulting from an evaluation of availability, expertise to a particular specialty, and other relevant parameters and will be described with particular reference thereto.

In conventional clinical diagnosis, case results from a clinician's own experience guide the clinician's decisions and diagnoses of ordinary patient cases. However, throughout the day clinicians often face a number of more complicated, unseen, or rare patient cases. Typically when facing such cases, clinician often needs to consult with trusted colleagues with similar expertise and experience to discuss these cases to help identify accurate diagnoses.

Communication tools, such as email or instant messaging exist, exist to help assist in the scheduling of such medical consultations. A disadvantage of using such communication tools is that the pool of colleagues is limited geographically or to colleagues that have had a previous relationship with the diagnosing clinician. With such a limited number of colleagues, the necessary experience and expertise may not be available to accurately diagnosis complicated, unseen, or rare cases. As more complicated, unseen, or rare cases are being faced, a larger community of colleagues is needed in order to properly and accurate diagnosis these cases. But, in the larger community it comes problematic to determine who to trust.

The present application provides a new and improved method of managing and facilitating medical consultations which overcomes the above-referenced problems and others.

In accordance with one aspect, a method for scheduling a medical consultation is provided. A list of consultation criteria is generated. A plurality clinician profiles stored in a server are searched in accordance with the consultation criteria. A list of consulting clinicians is generated from clinician profiles that correlate to the consultation criteria and displaying or storing in memory the list of the consulting clinicians.

In accordance with another aspect, a health care communication system is provided. A plurality of servers store prior patient cases and clinician profiles. Each of the plurality of servers has a search engine configured to search the prior patient cases and clinician profiles stored in the server in accordance with an information request to find correlating prior patient cases. A clinician computer includes a user interface configured to generate consultation criteria; a controller configured to generate information requests based on the consultation criteria and generate a listing of consulting clinicians based on correlating the clinician profiles and the consultation criteria; and a display which displays the listing of the consulting clinicians.

One advantage resides in the efficient scheduling of medical consultations.

Another advantage resides in the scheduling of medical consultations with colleagues with appropriate expertise and experience.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

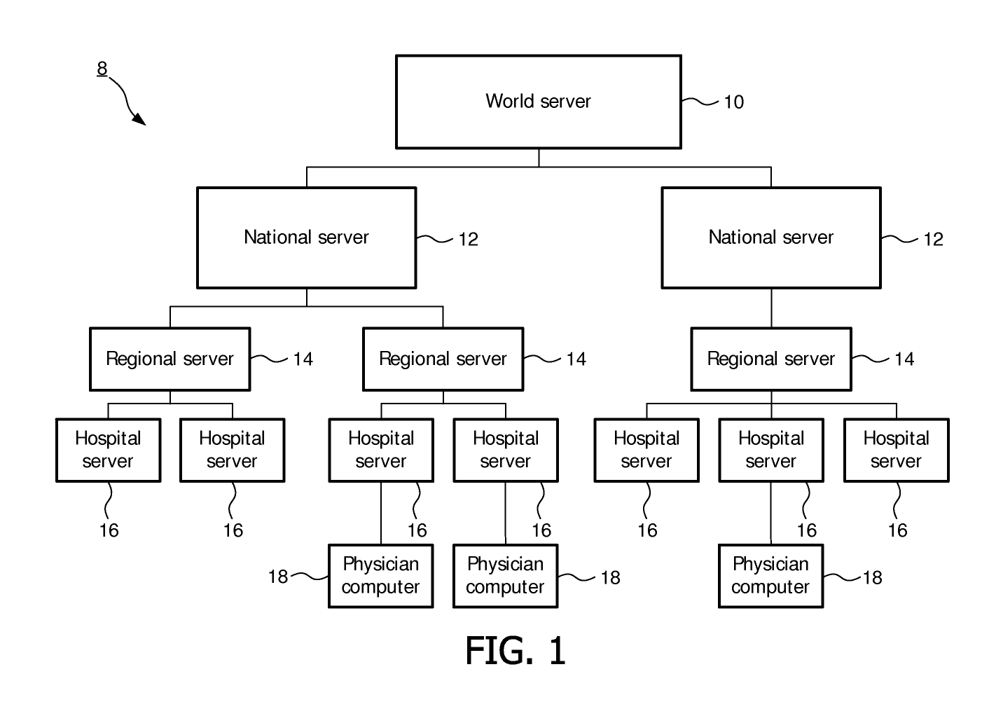

FIG. 1 is diagrammatic illustration of the health care network in accordance with the present application.

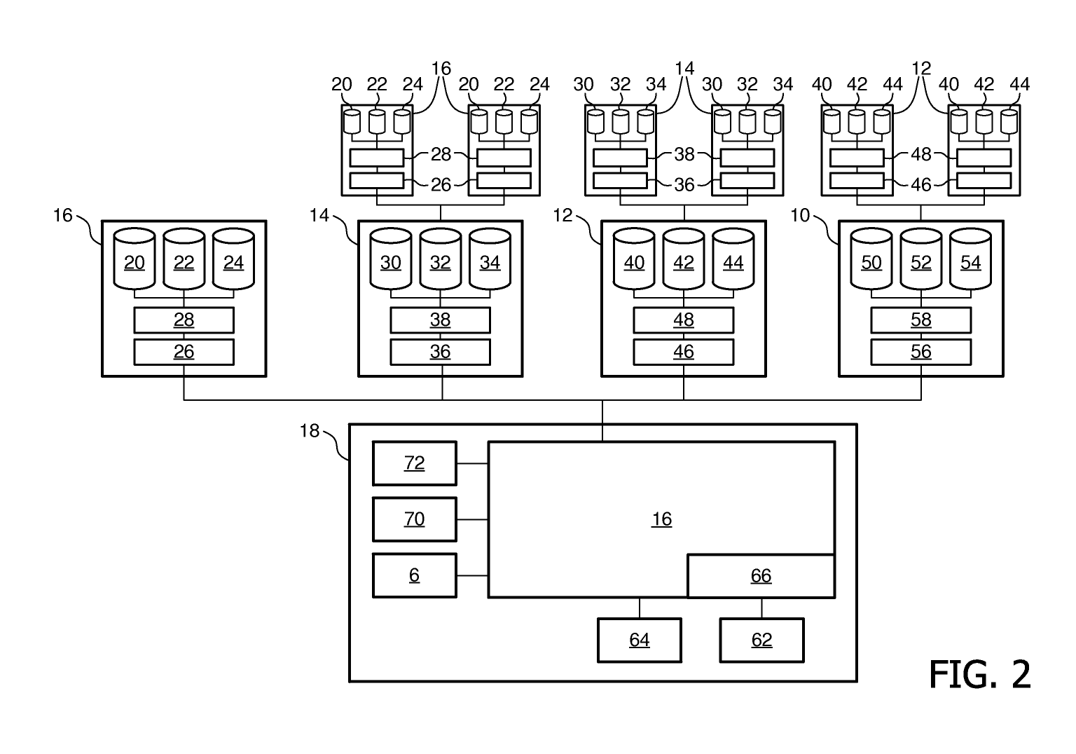

FIG. 2 is a diagrammatic illustration of the health care communication system in accordance with the present application.

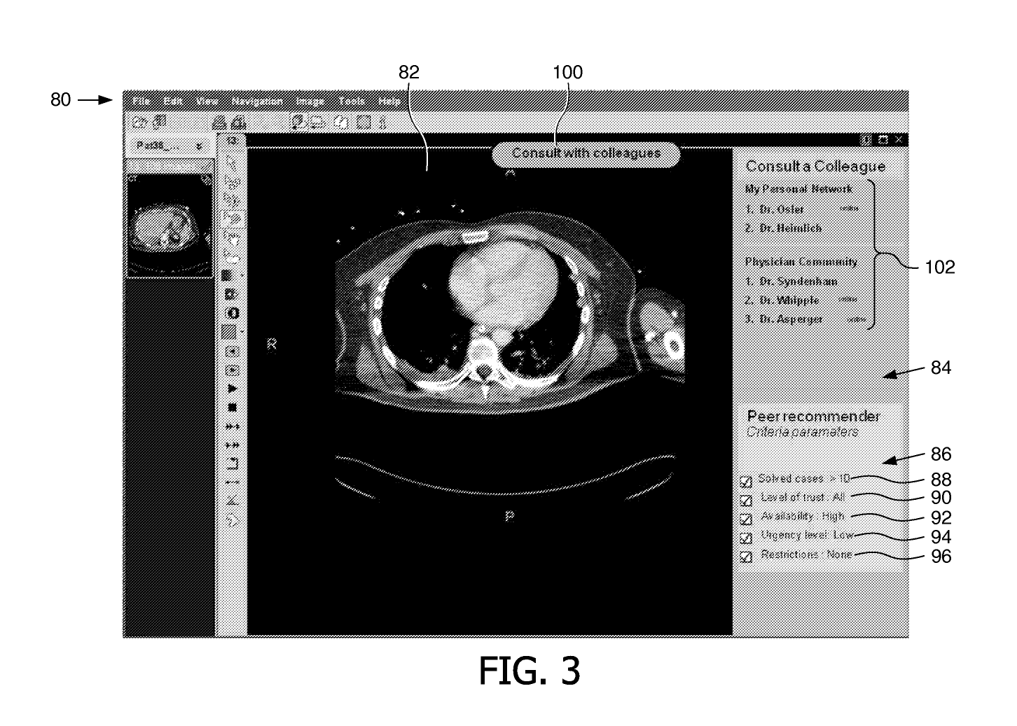

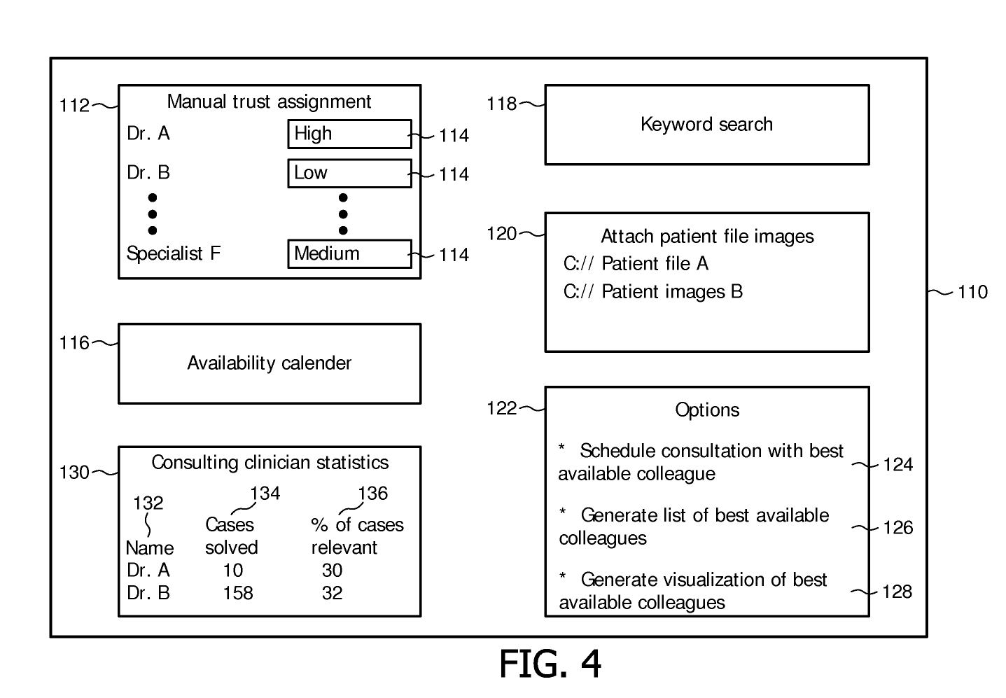

FIGS. 3 and 4 illustrate examples of the clinician computer interface in accordance with the present application.

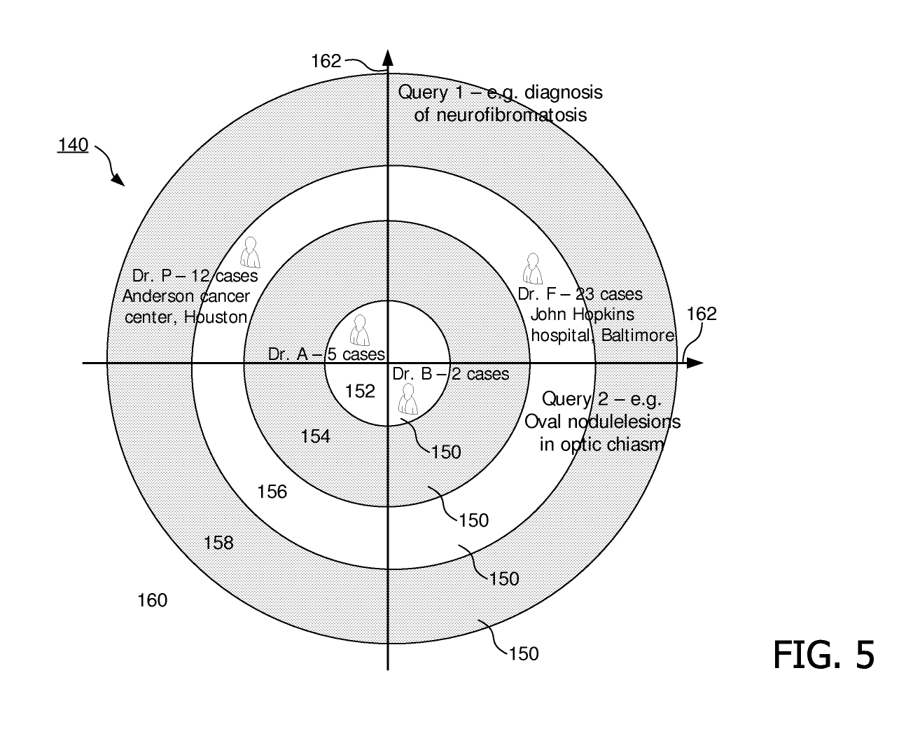

FIG. 5 illustrates an example of clinician computer visualization in accordance with the present application.

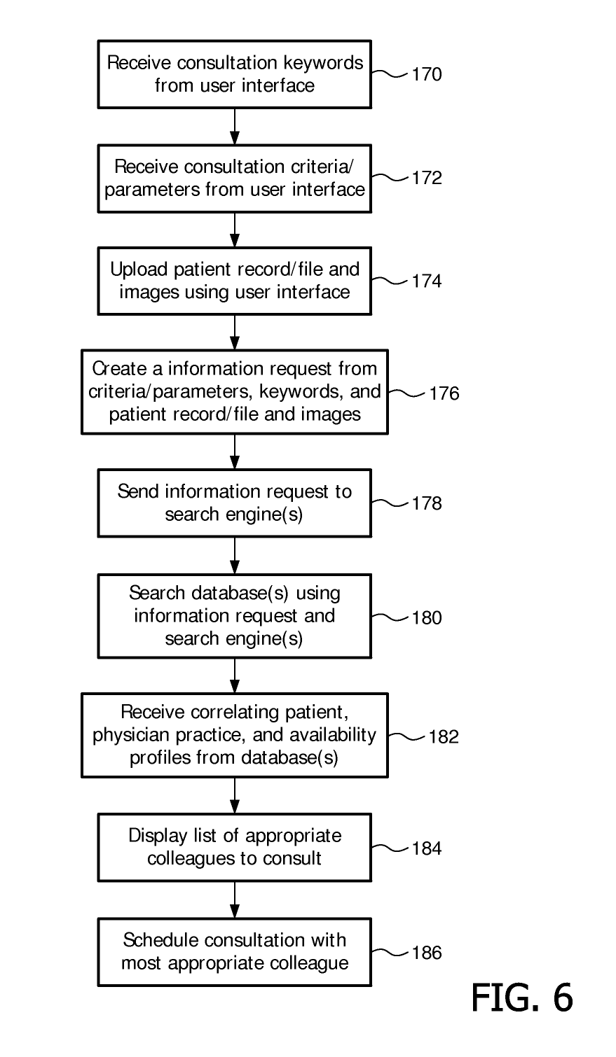

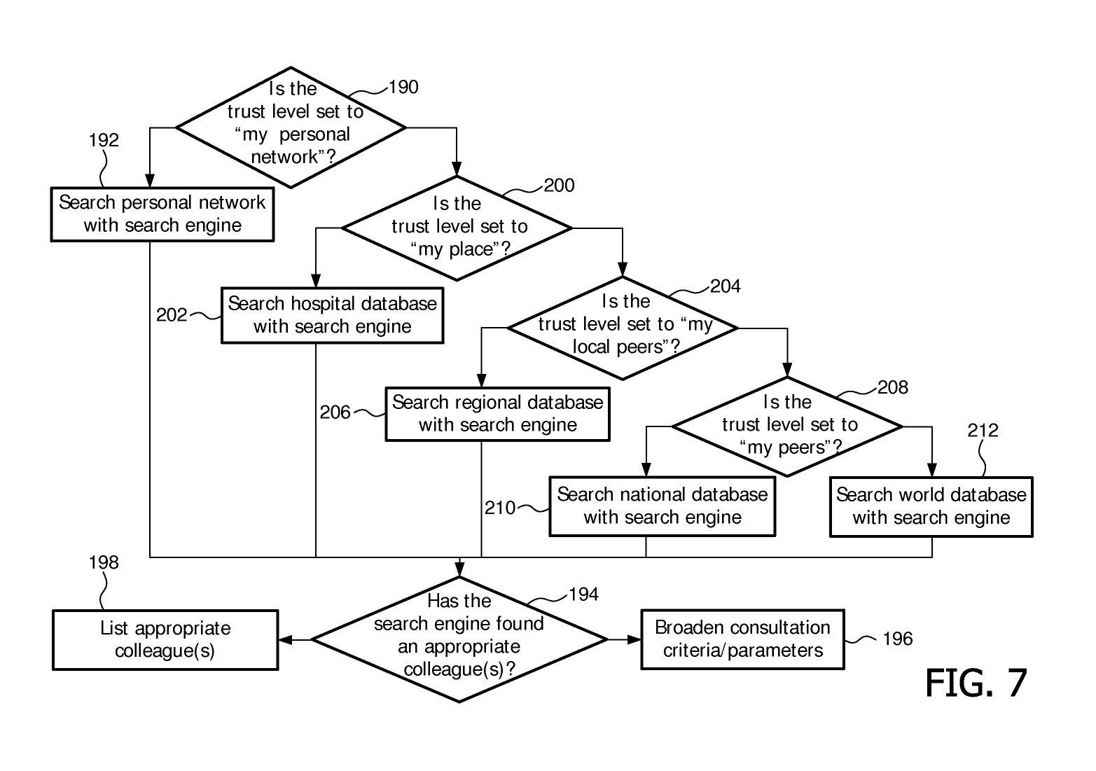

FIGS. 6 and 7 are flowchart diagrams of the operation of the health care communication system in accordance with the present application.

With reference to FIG. 1, a health care network includes a hierarchy of servers that provide access to a voluminous set of past patient cases. The patient cases are preferably searchable anonymously without accessing identifying information such as proper names, addresses, and so forth so as to comply with applicable privacy laws and standards. The network of patient cases may be derived from contents of a world server or top tier server 10, a plurality of national or other lower tier servers 12, a plurality of regional or other yet lower tier servers 14, and a plurality of hospital or local servers 16. The data of the patient cases includes patient images acquired through one or more medical imaging modalities, such as one or more of: computed tomography (CT) imaging; magnetic resonance (MR) imaging; positron emission tomography (PET) imaging; single photon emission computed tomography (SPECT) imaging; fluoroscopy imaging, ultrasound imaging, x-ray imaging; and the like. The data of the patient cases also include patient records, reports, and files, patient diagnoses and treatments, patient lab tests and findings, assigned or diagnosing clinicians, and the like. The health care network includes the world server 10 that is connected to the plurality of servers 12, such as the national servers, via a computer network, e.g. the internet, an intranet, or the like. Likewise, each national server 12 is connected via the computer network to a one or more of the plurality of servers 14, e.g. regional servers. The computer network additionally connects each regional server 14 to one or more of the plurality of hospital or hospital system servers 16 that are connected through the computer network to one or more of the plurality of clinician computers 18. Of course, other divisions of the data are also contemplated such as other geographic divisions as well as non geographic divisions, such as a group of servers dedicated to a particular professional organization or the like. It is contemplated that each of the servers or computers can be directly connected to each other through the computer network. It should be also be appreciated that while only two national servers, three regional servers, seven hospital servers, and three clinician computers are illustrated, more national servers, regional servers, hospital servers, and clinician computers are contemplated.

FIG. 2 is a diagrammatic illustration of health care communication system of the present application. A clinician computer 18 is connected to a hierarchy of servers such as the hospital server 16, the regional server 14, the national server 12, and the world server 10, through the computer network. The computer network additionally connects the regional server 14 to two different hospital servers 14, the national server 12 to two different regional servers 14, and the world server 10 to two different national servers 12. It should be also be appreciated that while only three national servers, three regional servers, three hospital servers, and one clinician computer are illustrated, more national servers, regional servers, and hospital servers are contemplated.

The hospital servers 16 include a patient database 20 that stores the hospital's past patient cases. A clinician database 22 stores the hospital's clinician, e.g., radiologist, practice profiles including the clinician's specialties, types of cases diagnosed, number of cases diagnosed, and the like. An availability database 24, such as a database that stores each clinician's personal calendar, stores the clinician's availability profiles including the dates and times clinicians are available to consult. The hospital servers 16 also include a controller 26 that receives information requests from the clinician computer 18. In response to receiving an information request from the clinician computer 18, the controller 26 controls a search engine 28 to search for requested information on the hospital's patient database 20, clinician database 22, and the availability database 24. The search engine 28 searches features of the hospital's patient cases, the diagnosing clinician, clinician practice profiles, and availability profiles to find correlations to the information request. Some illustrative examples of suitable features include keywords in a current patient records or files and image features such as patient symptoms, initial patient findings, initial image findings, inconclusive patient and image findings, tumor size, tumor aspect ratio, tumor tissue density as reflected by image intensity in the tumor region, and the like. The records of other patients can be searched for similar information to find patients with or who had a similar medical issue and which clinician provided the diagnosis. The correlating patient profiles, clinician practice profiles, and availability profiles are then transmitted by the controller 26 to the clinician computer 18. The controller 26 may include a processor or computer, software, or the like.

The regional servers 14 also includes a patient database 30 that stores region's past patient cases in an anonymized format, a clinician database 32 that stores the region's clinician practice profile, and an availability database 34 that stores the region's availability profiles. Alternatively the regional or other second tier servers 14 can access the hospital servers to access the various hospital databases. A controller 36 in the regional server 14 receives information requests from the clinician computer 18. In response to receiving an information request from the clinician computer 18, the controller 36 controls a search engine 38 to search for requested information on the region's patient database 30, clinician database 32, and the availability database 34. The search engine 38 searches features of the region's patient cases, clinician practice profiles, and availability profiles to find correlations to the information request. It is also contemplated that the regional server may also be connected to and searches the databases of any hospital servers 16 that are assigned to the particular region. The correlating patient profiles, clinician practice profiles, and availability profiles are then transmitted by the controller 36 to the clinician computer 18. The controller 36 may include a processor or computer, software, or the like.

The national or other next tier servers 12 also includes a patient database 40 that stores the nation's past patient cases in an anonymized format, a clinician database 42 that stores the nation's clinician practice profile, and an availability database 44 that stores the nation's availability profiles. Alternatively the national or other next tier servers 12 can access the hospital servers to access the various hospital databases such that its database is distributed. A controller 46 in the national server 12 receives information requests from the clinician computer 18. In response to receiving an information request from the clinician computer 18, the controller 46 controls a search engine 48 to search for requested information on the national's patient database 40, clinician database 42, and the availability database 44. The search engine 48 searches features of the nation's patient cases, clinician practice profiles, and availability profiles to find correlations to the information request. It is also contemplated that the national server may also be connected to and searches the databases of any regional 14 and hospital 16 servers that are assigned to the particular nation. The correlating patient profiles, clinician practice profiles, and availability profiles are then transmitted by the controller 46 to the clinician computer 18. The controller 46 may include a processor or computer, software, or the like.

The world or other top tier server 10 also includes a patient database 50 that stores the world's past patient cases anonymized, a clinician database 52 that stores the world's clinician practice profile, and an availability database 54 that stores the world's availability profiles. Alternatively the world or other top tier servers 10 can access the hospital servers to access the various hospital databases. A controller 56 in the world server 10 receives information requests from the clinician computer 18. In response to receiving an information request from the clinician computer 18, the controller 56 controls a search engine 58 to search for requested information on the world's patient database 50, clinician database 52, and the availability database 54. The search engine 58 searches features of the world's patient cases, clinician practice profiles, and availability profiles to find correlations to the information request. It is also contemplated that the world server may also be connected to and searches the databases of any national 12, regional 14, and hospital 16 servers. The correlating patient profiles, clinician practice profiles, and availability profiles are then transmitted by the controller 56 to the clinician computer 18. The controller 56 may include a processor or computer, software, or the like.

The clinician computer 18 includes a controller 60 that transmits information requests to and receives correlating patient cases, clinician practice profiles, and availability profiles from the hospital 16, regional 14, national 12, and world 10 servers. The controller 60 generates the information requests from parameters and keywords entered by a user through a user interface 62 or by accessing the patient data and images directly. The information requests may also be generated from any clinically significant aspects or features of the current patient case. The parameters and keywords quantify the clinically significant aspects of the current patient case and/or establish the requirements to be fulfilled by a consulting colleague. The user interface 62 can be a separate component or integrated into the display such as with a touch screen. The received correlating patient cases, clinician practice profiles, and availability profiles are then processed to determine if any colleagues have fulfilled the requirements of the consulting colleague and have diagnosed or had past experience with patient cases that share clinically significant aspects of the current patient case. The controller 60 also controls a display 64 to display profiles received from the servers that correlate to information requests. The clinician computer 18 may be a general purpose computer, a PDA, tablet PC, and the like.

The controller 60 also includes a processor 66, for example, a microprocessor which is configured to execute patient monitoring software for performing the operations described in further detail below and, optionally, scheduling medical consultations. Typically, medical consultation software will be stored in a memory 68 or a computer readable medium and be executed by the processor. Types of computer readable medium include memory such as a hard disk drive, CD-ROM, DVD-ROM and the like. Other implementations of the processor are also contemplated. Display controllers, Application Specific Integrated Circuits (ASICs), and microcontrollers are illustrative examples of other types of component which may be implemented to provide functions of the processor. Embodiments may be implemented using software for execution by a processor, hardware, or some combination thereof.

In another embodiment, the clinician computer 18 also includes a search engine 70 to search for requested information on all of the servers' patient databases, clinician databases, and the availability databases. The search engine 70 searches features in the patient cases, clinician practice profiles, and availability profiles to find correlations to the information request.

In another embodiment, a scheduling unit 72 evaluates the received correlating patient cases, clinician practice profiles, and availability profiles and schedules consultations with the colleagues that best fit the criteria and parameters set by the user. For example, the scheduling unit 72 compares the received correlating patient cases, clinician practice profiles, and availability profiles, to the criteria and parameters set by the user in the user interface 62 and/or to the clinically significant aspects of the current case. The scheduling unit 72 then schedules a consultation with the colleague that best fits the criteria and parameters set by the users and/or to the clinically significant aspects of the current case. In another embodiment, the scheduling unit 72 will provide a list of prior cases and the associated colleague who diagnosed the cases. The scheduling unit 72 may include a suitable programmed computer or processor, software applied by the processor, or the like.

As mentioned previously, the controller 60 directs the display to display profiles received from the servers that correlate to information requests. With reference to FIG. 3, the display 80 of the clinician computer 18 displays a current patient image 82 and a consultation interface 84. The consultation interface 84 includes a criteria sector 86 that allows the user input selected parameters in order to limit the search of the consulting colleagues. The criteria include the number of cases solved by the colleague 88, the level of trust of the colleagues 90, the availability of the colleagues 92, the urgency level of the current case 94, and any restrictions 96 input by the user. The display also includes a consult with colleague icon 100 with which the user interacts after the parameters and criteria are set in order to search for a consulting colleague. After the user interacts with the icon 100, a list of colleagues 102 that fulfill the parameters and criteria is displayed. The list 102 is sorted by the trust level of colleagues or ranked based on how many criteria were satisfied but other methods of sorting, for example by number of cases solved, availability or the like, are also contemplated.

After the correlating patient cases, clinician practice profiles, and availability profiles have been received by the controller 60 of the clinician computer 18, the controller 60 generates a list of consulting colleagues that have worked on patient cases that correlate to the current case, have the experience and expertise to assist in the current case, and/or the availability to consult with the diagnosing clinician. The list of parameters in the criteria sector 86 organize and order the list of consulting colleagues based on how many criteria were satisfied. The number of cases solved by a colleague parameter 88 limits consulting colleagues to only those colleagues that have diagnosed a certain number of a specific type of case. The trust level of the colleague parameter 90 limits consulting colleagues to only those colleagues that fulfill a required trust level. The trust level is implemented in the form of different circles of relationships. An example of possible trust levels from a high level of trust to a low level of trust include “My personal network” which are colleagues from the same department in the same hospital as the diagnosing clinician or had a previous workplace relationship with the diagnosing clinician; “My place” which are colleagues from the same hospital or set of hospitals that interact with each other in daily activities; “My local peers” which are colleagues that are located in the same sub-specialty or professional society within the local region; “My peers” which are colleagues that are same sub-specialty or professional society within the nation; and “Clinician community” which all colleagues in the same field within the nation or world. The availability of the colleague parameter 92 limits consulting colleagues to only those colleagues that have the available time to consult with the diagnosing clinician. The urgency level of the current case 94 limits consulting colleagues to only those colleagues that are available to consult in a specified near future time window due to the urgency of the current case. The restrictions parameter 96 is another filter to limit the list to local or not, radiologists names not to consider, or the like.

With reference to FIG. 4, the display 64 of the clinician computer 18 displays another consultation interface 110. A manual trust assignment 112 field allows the user to manually assign trust level 114 to different colleagues. The consultation interface 110 also includes an availability calendar 116 that allows the user to set the time and dates that he/she is are available to consult with colleagues. It is also contemplated that the availability calendar 116 may be uploaded from a personal calendar. The consultation interface 110 also includes further criteria parameters to allow the user to limit the search of the consulting colleagues. A keyword search sector 118 allows the user to input keyword that will limit the search of consulting colleagues to only those colleague that are associated with specified patient cases, clinician practice profiles, and availability profiles that contain a match or are similar to the keyword. A patient file and image sector 120 allows the user to upload a current patient file and images that can be used to generate information requests for searching the databases of the different servers. An options sector 112 allows the user to select certain options that alter the operation of the clinician computer 18. The options include automatically scheduling a consultation with the best available colleagues 124, generate a list of best available colleagues 126, and generate a visualization of the best available colleagues 128, and the like. A consulting clinician statistics sector 130 displays a list an appropriate consulting colleagues 132. The consulting clinician statistic sector 130 also displays the number of cases the colleague has diagnosed 134, the percentage 136 of those case that are relevant to the current patient case, and the like.

With reference to FIG. 5, the display 80 of the clinician computer 18 displays a visualization 140 of the colleagues available to consult. The visualization includes an icon 142 for each colleague that fulfills the parameters and criteria. The icon 142 includes the colleagues name 144, the number of cases the colleague has diagnosed 146, the location of the colleague 148, and the numbers of cases that a particular colleague has diagnosed (not shown) as well as the percentage of those cases that are relevant to the current patient case (not shown). The visualization also includes concentric circles 150 that represent the trust level of the colleague. The center circle 152 represents the highest level of trust such as the “Personal network”. The next circle 154 represents the next lowest level of trust such as the “My place” network. The next circle 156 represents the next lowest level of trust such as the “My local peers” network. The next circle 158 represents the next lowest level of trust such as the “My peers” network. The area outside of the circles 160 represents the lowest level of trust such as the “Clinician community”. Each axis 162 represents possible criteria (image findings, possible diagnoses) of the consulting colleague. The user may set each axis 162 to whatever criteria the user wish to view and can refresh the display with different axes. The icons 142 of the consulting colleague are positioned around the circle based on the trust level of the colleague and the closeness to the two selected criteria.

With reference to FIG. 6, illustrated is a flowchart of the operation of the health care communication system. At step 170, consultation keywords are received from the user interface. At step 172, consultation criteria and parameters are received from the user interface. At step 174, records/files and images of the patient to be diagnosed are uploaded by the diagnosing clinician using the user interface. At step 176, an information request is created from the criteria/parameters, keywords, and patient records/files and images. At step 178, the information request is sent to the search engine(s) 70. At step 180, the databases are searched using the information requests and the search engine(s). At step 182, corresponding patient cases, clinician practice profiles who diagnosed the corresponding cases as well as those who profiles match, and availability profiles, are received from the databases. At step 184, a list of appropriate colleagues is sorted by similarity to specified criteria and displayed. At step 186, a consultation is scheduled with the most appropriate colleague.

With reference to FIG. 7, illustrated is a flowchart of the operation performed by one or more processors of the health care communication system. At step 190, it is determined if the trust level of set to “My personal network”. In response to the trust level being set to “My personal network”, the hospital database is searched using the search engine for colleagues in the “My personal network” in a step 192. In a step 194, it is determined if the search engine has found an appropriate colleague. In response to not finding an appropriate colleague, the consultation parameters and criteria are automatically broadened in a step 196. In response to finding an appropriate colleague, the appropriate colleagues are displayed on a list in a step 198. In response to the trust level not being set to “My personal network”, it is determined if the trust level is set to “My place” in a step 200. In response to the trust level being set to “My place”, the hospital database is searched using the search engine for colleagues in the “My place” in a step 202. In a step 194, it is determined if the search engine has found an appropriate colleague. In response to not finding an appropriate colleague, the consultation parameters and criteria are automatically broadened in a step 196. In response to finding an appropriate colleague, the appropriate colleagues are displayed on a list in a step 198. In response to the trust level not being set to “My place”, it is determined if the trust level is set to “My local peers” in a step 204. In response to the trust level being set to “My local peers”, the regional database is searched using the search engine for colleagues in the “My local peers” in a step 206. In a step 194, it is determined if the search engine has found an appropriate colleague. In response to not finding an appropriate colleague, the consultation parameters and criteria are automatically broadened in a step 196. In response to finding an appropriate colleague, the appropriate colleagues are displayed on a list in a step 198. In response to the trust level not being set to “My local peers”, it is determined if the trust level is set to “My peers” in a step 208. In response to the trust level being set to “My peers”, the national database is searched using the search engine for colleagues in the “My peers” in a step 210. In a step 194, it is determined if the search engine has found an appropriate colleague. In response to not finding an appropriate colleague, the consultation parameters and criteria are automatically broadened in a step 196. In response to finding an appropriate colleague, the appropriate colleagues are displayed on a list in a step 198. In response to the trust level not being set to “My peers”, the word database is searched using the search engine for colleagues in the “My peers” in a step 212. In a step 194, it is determined if the search engine has found an appropriate colleague. In response to not finding an appropriate colleague, the consultation parameters and criteria are automatically broadened in a step 196. In response to finding an appropriate colleague, the appropriate colleagues are displayed on a list in a step 198.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for scheduling a medical consultation, the method comprising:
generating a list of consultation criteria;
searching a plurality of clinician profiles stored in a server in accordance with the consultation criteria;
generating a list of consulting clinicians from clinician profiles that correlate to the consultation criteria; and
displaying or storing in memory the list of the consulting clinicians.

2. The method according to claim 1, wherein generating the list of consultation criteria includes:
analyzing a file of a patient to be diagnosed to find patient characteristics.

3. The method according to claim 1, further including: searching patient case records for patients with patient characteristics similar to a patient to be diagnosed;
determining diagnosing clinicians of the patients with similar characteristics;
including the diagnosing clinicians in the list of consulting clinicians.

4. The method according to claim 1, further including:
ranking the consulting clinicians based on how many consultation criteria each consulting clinicians satisfies; and
scheduling a consultation with the highest ranked consulting clinician.

5. The method according to claim 1, wherein the consultation criteria include at least two of:
a specialty of a clinician;
a number of patient cases a clinician has diagnosed;
a trust level of a clinician; and
availability of a clinician.

6. The method according to claim 1, wherein the consultation criteria include trust levels including:
a personal network made up of clinicians in the same department as the clinician seeking the medical consultation;
a hospital network made up of clinicians a in the same hospital as the clinician seeking the medical consultation;
a peer network made up of clinicians with a same sub-specialty as the clinician seeking the medical consultation; and
a clinician network made up of clinicians with the same specialty as the clinician seeking the medical consultation.

7. The method according to claim 1, further including:
displaying the list of consulting clinicians in a visualization, the visualization including:
an icon for each of the consulting clinicians in the displayed list;
concentric circles to represent trust levels, wherein the circle closest to the center represents a highest level of trust and the circles further from the center represents lower levels of trust; and
two axes that each represent a selectable one of the consultation criteria.

8. The method according to claim 7, wherein each icon is positioned within the concentric circles based on relativity to the consultation criteria and trust level.

9. A health care communication system comprising:
a plurality of servers that store prior patient cases and clinician profiles, each of the plurality of servers having a search engine configured to search the prior patient cases and clinician profiles stored in the server in accordance with a information request;
a clinician computer including:
a user interface configured to generate consultation criteria;
a controller configured to generate information requests based on the consultation criteria and generate a listing of consulting clinicians based on correlating the clinician profiles and the consultation criteria; and
a display which displays the listing of the consulting clinicians.

10. The system according to claim 9, wherein the controller ranks the consulting clinicians based on how many consultation criteria each consulting clinicians satisfies and schedules a consultation with a highest ranked consulting clinician.

11. The system according to claim 9, wherein the display displays the list of consulting clinicians in a visualization, the visualization including:
an icon for each of the consulting clinicians in the list;
concentric circles to represent trust levels, wherein the circle closest to the center represents a highest level of trust and the circles further from the center represents lower levels of trust; and
two axes that each represent a selectable one of the consultation criteria.

12. The system according to claim 9, wherein each icon is positioned within the concentric circles based on relativity to the consultation criteria and trust level.

13. The system according to claim 9, wherein the plurality of servers that store prior patient cases and clinician profiles include:
a top tier server;
a plurality of intermediate tier servers;
a plurality of hospital or lower tier servers.

14. The system according to claim 9, wherein generating the list of consultation criteria includes:
analyzing a file of a patient to be diagnosed to patient characteristics.

15. The system according to claim 9, wherein the controller searches patient case records for patients with patient characteristics similar to a patient to be diagnosed;
determines diagnosing clinicians of the patients with patient characteristics similar to the patient to be diagnosed; and
considers the diagnosing clinicians for the list of consulting clinicians.

16. The system according to claim 9, wherein the consultation criteria include at least two of:
a specialty of a clinician;
a number of patient cases a clinician has diagnosed;
a trust level of a clinician; and
availability of a clinician;

17. The system according to claim 9, wherein the consultation criteria include trust levels including:
a personal network made up of clinicians in the same department as the clinician seeking the medical consultation;
a hospital network made up of clinicians a in the same hospital as the clinician seeking the medical consultation;
a peer network made up of clinicians with a same sub-specialty as the clinician seeking the medical consultation; and
a clinician network made up of clinicians with the same specialty as the clinician seeking the medical consultation.
